(19) United States
(12) Patent Application Publication
(10) Pub. No.: US 2015/0113436 A1
(43) Pub. Date: Apr. 23, 2015

(54) Providing Enhanced Message Management User Interfaces

(71) Applicant: Citrix Systems, Inc., Fort Lauderdale, FL (US)

(72) Inventors: Priscila K. Penha, San Francisco, CA (US); Kelly M. Nash, San Mateo, CA (US); Daisuke Sakurai, San Francisco, CA (US); Shih-Hao Yeh, San Francisco, CA (US)

(21) Appl. No.: 14/513,319

(22) Filed: Oct. 14, 2014

Related U.S. Application Data
(60) Provisional application No. 61/892,818, filed on Oct. 18, 2013.

(51) Int. Cl. G06F 3/0485; H04L 12/58; G06F 3/0481

(52) U.S. Cl. CPC G06F 3/0485; G06F 3/0481; H04L 51/04
USPC 715/752

(57) ABSTRACT

Methods, systems, and computer-readable media for providing enhanced message management user interfaces are presented. In some embodiments, a computing device may present a user interface comprising a scrollable content display region that includes at least two message cards and at least two target zones. The computing device may receive first input moving a first message card to a first target zone. In response to receiving the first input, the computing device may perform a first action on a first email message corresponding to the first message card. Thereafter, the computing device may receive second input moving a second message card to a second target zone. In response to receiving the second input, the computing device may perform a second action different from the first action on a second email message corresponding to the second message card. At least one action may be defined by a user of the computing device.

### CROSS-REFERENCE TO RELATED APPLICATIONS

This application claims the benefit of U.S. Provisional Patent Application Ser. No. 61/892,818, filed Oct. 18, 2013, and entitled “PROVIDING ENHANCED MESSAGE MANAGEMENT USER INTERFACES,” and which is incorporated by reference herein in its entirety.

### BACKGROUND

Aspects of the disclosure generally relate to computing hardware and computer software. In particular, one or more aspects of the disclosure relate to computing hardware and computer software for providing enhanced message management user interfaces.

Various kinds of computing devices, from personal computers to mobile devices, are becoming increasingly popular. In addition, people are increasingly using these devices for both business purposes and personal uses. As these devices continue to grow in popularity and people continue to use them for an ever-growing number of reasons, the users of these devices have demanded and will continue to demand greater convenience, functionality, and ease-of-use from their computing devices and the computer software with which they interact.

### SUMMARY

Aspects of the disclosure relate to various systems and techniques that provide more convenient, functional, and easy-to-use ways for users to interact with user interfaces provided by computing devices and/or computer software.

For example, electronic mail or “email” is a highly popular form of communication, and many people increasingly use email to communicate with business colleagues, personal friends, and many other people. For many email users, however, the volume of messages that may be received in their inboxes can be relatively large, almost to the point of being overwhelming. Some existing email applications attempt to address this and other issues by providing a small message preview box in connection with a list view of an email inbox or other email folder. This message preview box, however, often does not provide enough information for an email user to make a decision about how to handle the email message and/or understand what action(s), if any, may be required by the message.

Certain aspects of the disclosure provide efficient, effective, and convenient ways of quickly clearing out unwanted email messages so that an email user can efficiently and effectively access the messages that they are interested in and/or that they may wish to act upon. In particular, aspects of the disclosure provide ways of allowing an email user to have a relatively larger preview of their email messages, so that they can quickly browse through email messages in their inbox or in other email folders. In addition, aspects of the disclosure provide ways of allowing an email user to quickly sort, move, archive, delete, and/or otherwise eliminate unwanted messages, thereby leaving the email user's inbox with the content that they may be truly interested in viewing.

In accordance with one or more aspects of the disclosure, a computing device may present a user interface comprising a scrollable content display region that includes at least two message cards and at least two target zones arranged along at least two different sides of the scrollable content display region. Each message card may correspond to an email message. Subsequently, the computing device may receive first input moving a first message card of the at least two message cards to a first target zone of the at least two target zones. In response to receiving the first input, the computing device may perform a first action on a first email message corresponding to the first message card. Thereafter, the computing device may receive second input moving a second message card of the at least two message cards to a second target zone of the at least two target zones. In response to receiving the second input, the computing device may perform a second action different from the first action on a second email message corresponding to the second message card. In addition, at least one action of the first action and the second action may be defined by a user of the computing device.

In some embodiments, after performing the second action on the second email message, the computing device may update the user interface to place a third message card in focus in the scrollable content display region. In some instances, the computing device then may receive third input corresponding to a double tap on the third message card. In response to receiving the third input, the computing device may set at least one flag for a third email message corresponding to the third message card. In other instances, a third email message corresponding to the third message card may be associated with a conversation group that includes at least two email messages, and the at least two email messages included in the conversation group may be presented as an expandable stack in the scrollable content display region.

In some embodiments, after performing the second action on the second email message, the computing device may determine that at least one action has been performed on all email messages for which a message card was presented in the scrollable content display region. In response to determining that at least one action has been performed on all email messages for which a message card was presented in the scrollable content display region, the computing device may update the user interface to remove the scrollable content display region and the at least two target zones.

In some embodiments, a read-unread flag associated with each of the email messages corresponding to the at least two message cards may be preserved after the at least two message cards are presented in the scrollable content display region.

In some embodiments, a single message card of the at least two message cards may be in focus in the scrollable content display region at a time, and one or more other message cards of the at least two message cards may be presented differently than the single message card that is in focus in the scrollable content display region. In some instances, the single message card that is in focus in the scrollable content display region may include a preview of the email message corresponding to the single message card, and an amount of message content presented in the preview may be substantially similar to an amount of message content presented in a full-screen view of the email message corresponding to the single message card.

In some embodiments, performing the first action on the first email message may include causing a contextual menu to be presented, and the contextual menu may be configured to prompt a user to select a destination folder for the first email message.

In some embodiments, the computing device may receive third input moving a third message card of the at least two message cards to the first target zone of the at least two target zones, and the third input may include a first gesture different from a second gesture used in moving the first message card to the first target zone. In response to receiving the third input, the computing device may perform a third action different from the first action on a third email message corresponding to the third message card. In some instances, the first gesture may be a two-finger swipe and the second gesture may be a one-finger swipe. Additionally or alternatively, performing the third action may, in some instances, include performing an operation on a group of email messages that includes the third email message and one or more email messages related to the third email message.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein.

FIGS. 2-5 depict example user interfaces that may be displayed in accordance with one or more illustrative aspects discussed herein.

FIGS. 6-10 depict flowcharts that illustrate methods of providing enhanced message management user interfaces in accordance with one or more illustrative aspects discussed herein.

FIG. 11 depicts an example of a system for providing enhanced message management user interfaces in accordance with one or more illustrative aspects discussed herein.

### DETAILED DESCRIPTION

In the following description of the various embodiments, reference is made to the accompanying drawings identified above, which form a part hereof, and in which is shown by way of illustration various embodiments in which various aspects of the disclosure may be practiced. Other embodiments may be utilized, and structural and functional modifications may be made, without departing from the scope discussed herein. Various aspects are capable of other embodiments and of being practiced or being carried out in various different ways. In addition, the phraseology and terminology used herein are for the purpose of description and should not be regarded as limiting. Rather, the phrases and terms used herein are to be given their broadest interpretation and meaning The use of “including” and “comprising” and variations thereof is meant to encompass the items listed thereafter and equivalents thereof as well as additional items and equivalents thereof

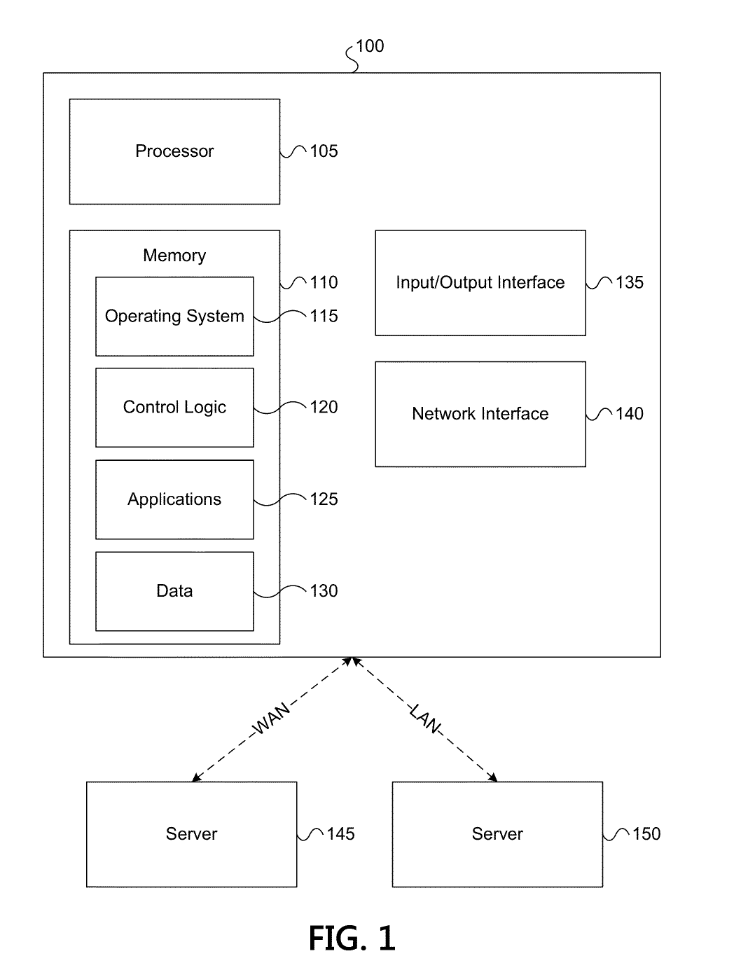

As noted above, certain embodiments are discussed herein that relate to providing enhanced message management user interfaces. Before discussing these concepts in greater detail, however, several examples of a computing device that may be used in implementing and/or otherwise providing various aspects of the disclosure will first be discussed with respect to FIG. 1.

FIG. 1 depicts an example of a computing device 100 that may be used in implementing one or more aspects of the disclosure in accordance with one or more illustrative aspects discussed herein. For example, computing device 100 may, in some instances, implement one or more aspects of the disclosure by reading and/or executing instructions and performing one or more actions accordingly. In one or more arrangements, computing device 100 may represent, be incorporated into, and/or include a desktop computer, a computer server, a mobile device (e.g., a laptop computer, a tablet computer, a smart phone, any other type of mobile computing device, etc.), and/or any other type of data processing device. Computing device 100 may, in some instances, operate in a standalone environment. In other instances, computing device 100 may operate in a networked environment. For example, computing device 100 may, in some instances, be connected to and/or otherwise in communication with one or more other computing devices that may be local to and/or physically remote from computing device 100.

As seen in FIG. 1, computing device 100 may, in some embodiments, include a processor 105, memory 110, an input/output interface 135, and a network interface 140. These are only some examples of the components and/or subsystems that may be included in computing device 100 in some embodiments. In other embodiments, computing device 100 may include two or more of any and/or all of these components (e.g., two or more processors, two or more memories, etc.) and/or other components and/or subsystems not listed here.

In some embodiments, processor 105 may control overall operation of computing device 100, including operation of one or more of the other components included in computing device 100, such as memory 110, input/output interface 135, and/or network interface 140. Memory 110 may, for instance, store software, instructions, data, and/or other information. For example, software may be stored in memory 110 and/or other storage to provide instructions to processor 105 for configuring the generic computing device 100 into a special purpose computing device in order to perform one or more of the various functions discussed herein.

In some arrangements, memory 110 may store, provide, and/or otherwise include an operating system 115, control logic 120, one or more applications 125, and/or data 130. Operating system 115 may, for example, control overall operation of computing device 100. Control logic 120 may, for instance, instruct computing device 100 and/or various components included therein, including processor 105, to perform and/or otherwise provide various aspects of the disclosure. The one or more applications 125 may, for example, provide secondary, support, and/or other functionalities that may be used in conjunction with various aspects of the disclosure. Additionally, data 130 may, for instance, be used in performing one or more aspects of the disclosure and, in some instances, may include one or more databases, data tables, and/or the like.

In some arrangements, input/output interface 135 may include a keyboard, mouse, display, printer, scanner, optical reader, stylus, and/or one or more other components. For example, input/output interface 135 may include various interface units and/or drives for reading, writing, displaying, and/or printing files and/or other data. In some embodiments, input/output interface 135 may include an audio interface that includes one or more microphones for capturing audio input and/or one or more speakers for providing audio output. Additionally or alternatively, input/output interface 135 may include a video display device for providing textual, audiovisual, and/or graphical output.

In some embodiments, at least one display included in and/or otherwise provided by input/output interface 135 may be a touch-sensitive display screen (also known as a “touch screen”). Such a touch screen may, for instance, be configured to display graphical content rendered and/or otherwise generated by computing device 100. In addition, the touch screen may be configured to receive user input from a user of computing device 100, including touch-based user input provided by the user using a stylus, finger, or other pointing aspect that is operated, controlled, and/or otherwise used by the user of the computing device 100 to interact with the touch screen.

As indicated above, computing device 100 may, in some instances, operate in a networked environment supporting connections to one or more remote computers, servers, and/or devices. Such connectivity may, in some embodiments, be provided by network interface 140. For example, network interface 140 may include one or more communication interfaces, ports, adapters, antennas, and/or other elements to facilitate various network connections. Such network connections may include local area network (LAN) connections, wide area network (WAN) connections (e.g., to the Internet), and/or any other types of connections. In some arrangements, LAN connections may be established and/or provided via a dedicated LAN interface and/or adapter, and/or WAN connections may be established and/or provided via a dedicated WAN interface and/or adapter. Other connections may, for example, be established and/or provided via other communication interfaces, such as wired communication interfaces (e.g., Ethernet), wireless communication interfaces (e.g., wireless LAN (WLAN), cellular, Bluetooth, etc.), and/or other communication interfaces.

As seen in FIG. 1, computing device 100 may, in some instances, be connected to and/or in communication with one or more servers, such as server 145 and server 150. Such servers may, for instance, implement one or more aspects of computing device 100 and, accordingly, may include one or more processors, memories, and/or the like. Some connections to the one or more servers may be established via a LAN (e.g., the connection between computing device 100 and server 145), while other connections to the one or more servers may be established via a WAN (e.g., the connection between computing device 100 and server 150). In some embodiments, some or all of the one or more servers may be virtual servers that are provided by software being executed on one or more computing devices.

In addition, one or more aspects of the disclosure may be embodied in computer-usable or readable data and/or computer-executable instructions, such as in one or more program modules, executed by one or more computers or other devices as discussed herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a nonvolatile storage device. Any suitable computer readable storage media may be utilized, including hard disks, CD-ROMs, optical storage devices, magnetic storage devices, and/or any combination thereof. In addition, various transmission (non-storage) media representing data or events as discussed herein may be transferred between a source and a destination in the form of electromagnetic waves traveling through signal-conducting media such as metal wires, optical fibers, and/or wireless transmission media (e.g., air and/or space). Various aspects discussed herein may be embodied as a method, a data processing system, or a computer program product. Therefore, various functionalities may be embodied in whole or in part in software, firmware, and/or hardware or hardware equivalents such as integrated circuits, field programmable gate arrays (FPGA), and the like. Particular data structures may be used to more effectively implement one or more aspects of the disclosure, and such data structures are contemplated as being within the scope of computer executable instructions and computer-usable data discussed herein.

Further, some aspects of the disclosure may also be operational with numerous other general purpose or special purpose computing system environments or configurations. Examples of other computing systems, environments, and/or configurations that may be suitable for use with aspects discussed herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Having discussed several examples of the computing system architecture that may be used in providing and/or implementing various aspects of the disclosure, a number of embodiments will now be discussed in greater detail. In particular, and as introduced above, some aspects of the disclosure generally relate to providing enhanced message management user interfaces. In the description below, various examples illustrating how such user interfaces may be provided in accordance with one or more embodiments will be discussed.

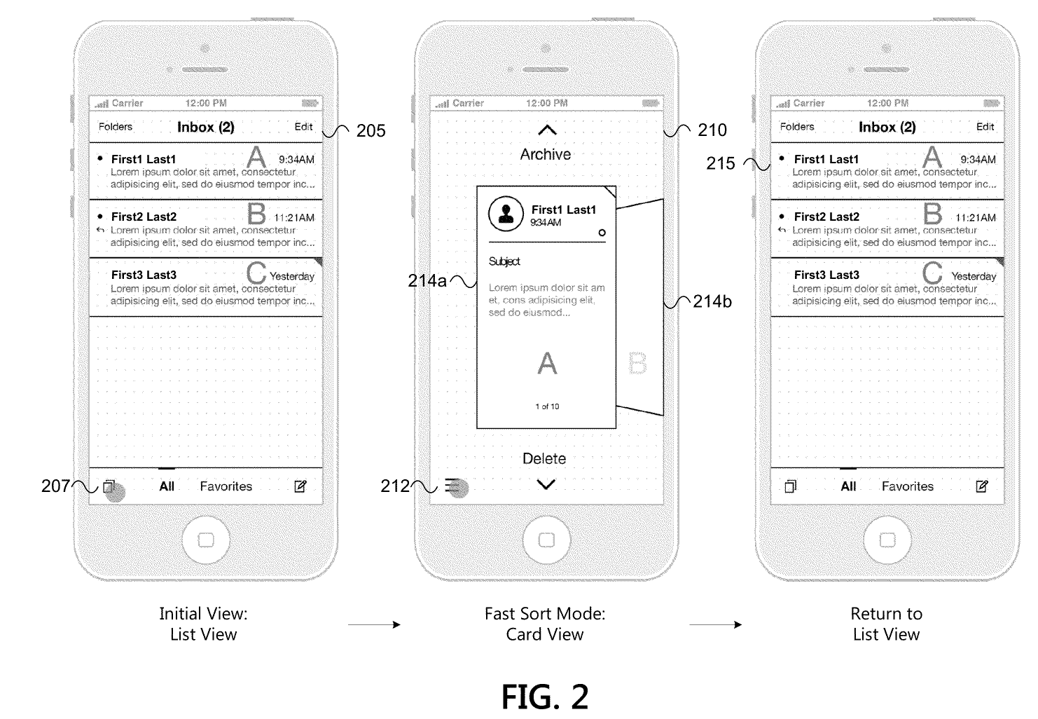

FIGS. 2-5 depict example user interfaces that may be displayed in accordance with one or more illustrative aspects discussed herein. In one or more embodiments, the example user interfaces illustrated in FIGS. 2-5 may be displayed and/or otherwise presented by a computing device, such as computing device 100.

As illustrated in the examples discussed below, one or more aspects of the disclosure may be implemented as an operational mode of a software application, such as an email client or other type of email application. In several of the examples discussed below, this operational mode may, in some instance, be referred to interchangeably as a “Fast Sort” mode or as a “Card View” mode.

For example, FIG. 2 illustrates several example user interfaces of an email client application that may incorporate various aspects of the disclosure. As seen in example user interface 205, a user may cause a computing device presenting user interface 205 to enter a Fast Sort mode by tapping on a Card View icon 207 in the bottom left corner of user interface 205, which may present a view of an email inbox associated with the user of the computing device. After entering the Card View mode, which is illustrated in example user interface 210, the computing device may allow the user to toggle back to the inbox by tapping or otherwise selecting the List View icon 212 which appears in the bottom left corner of the Card View interface. This return to the List View, caused by toggling back to the inbox, is illustrated in example user interface 215 shown in FIG. 2. Card View may show all messages that are currently in the user's inbox; and the objects displayed in the interface (e.g., the various messages that may be included in the inbox) may have, in the Card View, the same properties (such as, for instance, message indicators like message flags, unread/read status flags, replied to flags, forwarded flags, etc.) that these messages possess in List View.

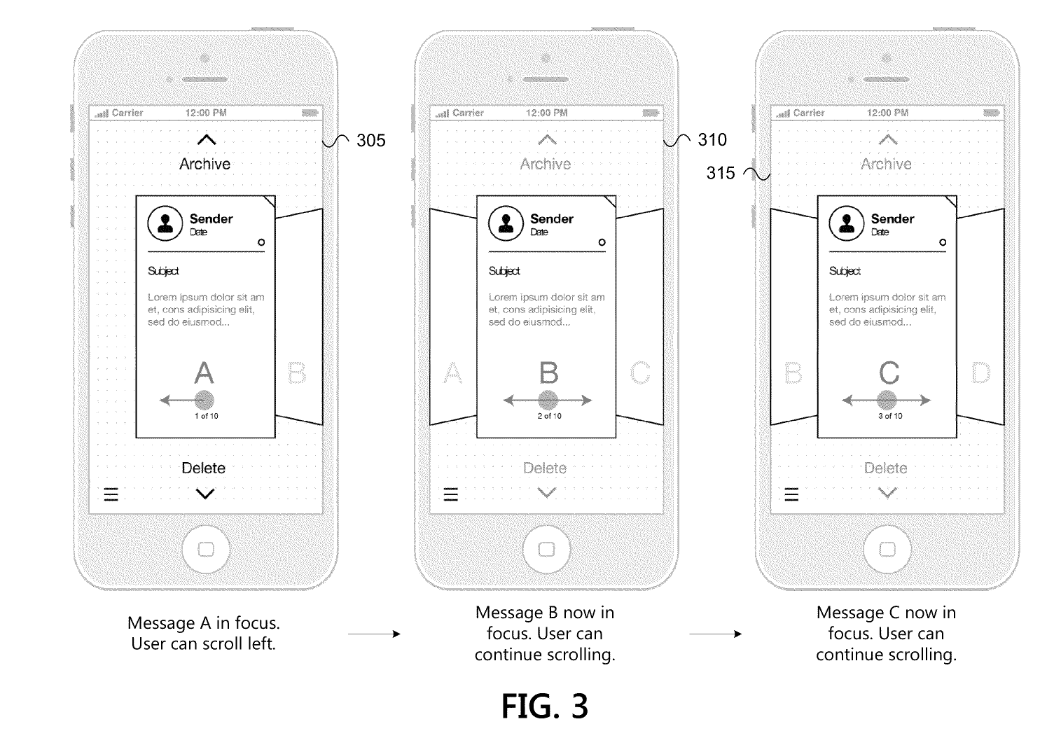

FIG. 3 illustrates several more example user interfaces of an email client application that may incorporate various aspects of the disclosure. In particular, FIG. 3 illustrates scrolling behaviors that may be performed in Card View after the email client application has entered the Fast Sort mode discussed above. As seen in FIG. 3, the computing device and/or the email client application running on the computing device may display and/or otherwise present, and a user may view, a relatively larger preview of the emails residing in their inbox (e.g., as compared to the preview that may be displayed and/or otherwise presented in a conventional message preview box). Additionally, in Card View, messages may be shown in the same sort order that they appear in the List View of the inbox. The computing device and/or the email client application running on the computing device may be configured so as to allow the user to scroll through the messages by swiping left to right or right to left, thereby moving forward or backward in the inbox list. In addition, the computing device and/or the email client application running on the computing device may be configured so that messages maintain the same properties in the inbox when displayed in Card View (e.g., the read-unread flag of a message might not be altered even though the message may be presented in Card View) unless acted upon by the user (e.g., unless the user archives the message, deletes the message, performs some other action on the message, etc.).

For example, when example user interface 305 is presented, the user of the computing device presenting user interface 305 may swipe left to view another message card that may correspond to the next message in the user's inbox. Based on receiving such a swipe command and/or other input, the computing device may present example user interface 310 in which such a message card is presented. When example user interface 310 is presented, the user of the computing device may swipe right to return to the previously displayed message card (which may, e.g., cause the computing device to once again present example user interface 305) and/or may swipe left to view yet another message card that may correspond to the next message in the user's inbox. Based on receiving such a left swipe command and/or other input, the computing device may present example user interface 315 in which the next message card is presented.

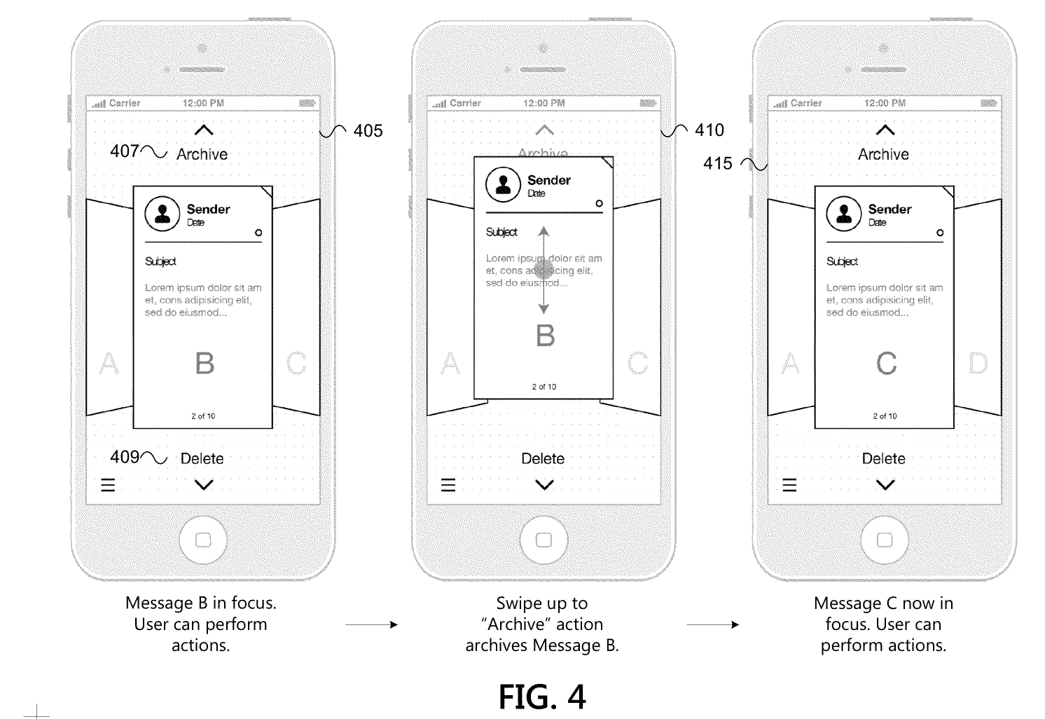

FIG. 4 illustrates several more example user interfaces of an email client application that may incorporate various aspects of the disclosure. In particular, FIG. 4 illustrates how the computing device and/or the email client application running on the computing device may be configured to allow a user to perform one or more actions on a message by moving a card corresponding to the message towards various target zones which may, for instance, be mapped to different actions. For example, as seen in example user interface 405 shown in FIG. 4, when in the Card View mode, the computing device and/or the email client application running on the computing device may allow a user to execute a first possible action via a first target zone 407 at the top of the screen and a second possible action via a second target zone 409 at the bottom of the screen. By interacting with the illustrated user interface, the user can cause the computing device and/or the email client application running on the computing device to perform an action on an object, which may be a card representing an email message, by swiping the object up or down to the corresponding target zone and action label (e.g., at the top of the screen or at the bottom of the screen). In this way, the computing device and/or the email client application running on the computing device may be configured to allow the user to scroll left and right through various messages in their inbox, and also scroll up and down to quickly sort messages, delete messages (e.g., to clear out their inbox and/or otherwise remove content), and/or otherwise perform various actions on the messages that may be included in their inbox. This scrolling and sorting functionality is illustrated, for instance, in example user interfaces 410 and 415, which are also shown in FIG. 4. For example, in user interface 410, the user of the computing device may be swiping a message card up to the target zone associated with an “archive” action, thus causing the computing device and/or the email application running on the computing device to archive the message corresponding to the message card, and in user interface 415, a message card corresponding to the next message in the user's inbox may be displayed (e.g., after the previously-displayed message has been archived).

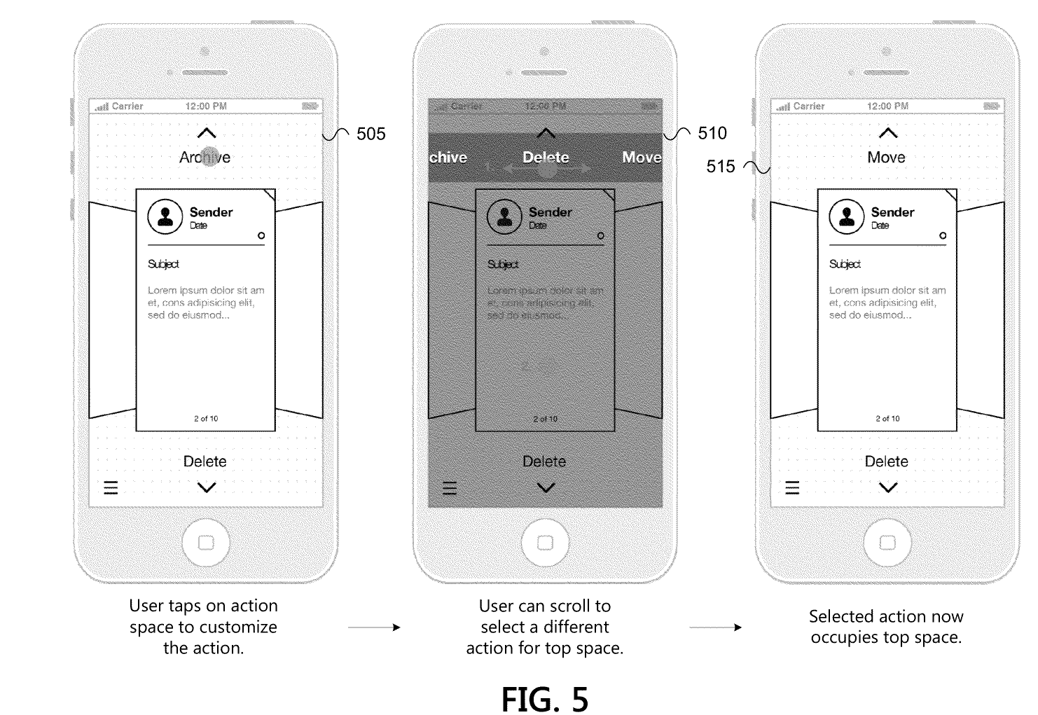

FIG. 5 illustrates several more example user interfaces of an email client application that may incorporate various aspects of the disclosure. In particular, the example user interfaces shown in FIG. 5 illustrate how the computing device and/or the email application running on the computing device may be configured to allow a user to customize one or more of the actions that may be performed when, for instance, a card corresponding to a message is moved to a particular target zone in the Fast Sort mode discussed above.

For example, as seen in the example user interfaces shown in FIG. 5, the computing device and/or the email application running on the computing device may be configured to allow a user to define and/or change the action assigned to the top or bottom target zone (e.g., depending on the task(s) that the user may wish to perform).

To accomplish this change, a user may tap on the action that he or she may wish to modify, as illustrated in example user interface 505. Upon receiving this tap input from the user, the computing device and/or the email application running on the computing device may activate and/or otherwise present a sliding menu, as is illustrated in example user interface 510. Once the sliding menu is displayed, the computing device and/or the email application running on the computing device may be configured so as to allow the user to scroll left and right through the sliding menu to select an action to occupy the target zone. For instance, as illustrated in example user interface 510, the computing device and/or the email application running on the computing device may be configured so as to allow the user to scroll left and right through the sliding menu to select an action to occupy the top target zone. After making a selection within the sliding menu, the computing device and/or the email application running on the computing device may be configured so as to allow the user to exit the selection menu by tapping anywhere else on the screen, as illustrated in example user interface 515.

As illustrated above, one or more aspects of the disclosure may provide various benefits over conventional email clients. For example, the Fast Sort mode discussed above may be particularly convenient when used on a mobile computing device, as the Fast Sort mode may enable a user of such a device to view and sort email messages using only one hand (e.g., the user can hold their smartphone, tablet computer, or other mobile device in the palm of one hand, and then scroll through and sort messages using their thumb of that hand). In addition, this relatively easy and convenient scrolling view, combined with the larger message preview provided in the Card View, may allow a user to quickly sort through a large volume of email content in a short amount of time in a way that may be similar to how a user may sort through physical mail received in a physical mailbox (e.g., sorting the mail into a group of messages to be read, a group of messages to be recycled, and a group of messages to be flagged for additional action).

Furthermore, the Fast Sort mode may be relatively simple for a user to use and may be provided in addition to a traditional List View for an email inbox. Thus, a user might not be required to use this functionality in order to maximize their experience within an email client incorporating various aspects of the disclosure. Rather, should they wish, the user may be able to completely and effectively utilize the email client even if they choose to bypass the Fast Sort mode altogether.

In addition, the Fast Sort mode discussed above may be highly customizable, as it may allow a user to change the top and bottom target zone, and thus their message sorting options, to fit the user's particular, individual email sorting behaviors. The Fast Sort mode discussed above may also enable a user to quickly preview their email inbox while allowing messages to maintain their current properties (e.g., messages might not be marked as “read” after they are displayed in the Card View of the Fast Sort mode; other message properties, such as flags, might not be modified in the Card View of the Fast sort mode unless an action is deliberately performed upon the message by the user; etc.).

Still other features and/or benefits may be provided by one or more aspects of the disclosure. For example, in the Fast Sort mode discussed above, the computing device and/or the email application running on the computing device may be configured so as to allow the user to scroll through email previews without having to take an explicit action. In other words, in the Fast Sort mode discussed above, the computing device and/or the email application running on the computing device may be configured such that the user might not be required to archive, keep, or reply to a message before the user can move on to viewing the next message card associated with the next message. Moreover, in the Fast Sort mode, if the user decides to keep a message (e.g., by scrolling past it), the computing device and/or the email application running on the computing device may be configured so as to allow the user to still return to and see the message again within the Fast Sort mode (e.g., by scrolling back to it). In this way, the Fast Sort mode may, at all times, provide the user with an accurate snapshot of his or her inbox.

As another example, the Fast Sort mode discussed above may allow a user to select their preferred sorting actions to conform to their unique individual behaviors. For instance, a user can change the “archive” action associated with the target zone at the top of the screen to a “move” action, as discussed above with respect to FIG. 5. Moreover, the computing device and/or the email application running on the computing device may be configured so as to allow the user to change such a selection easily at any time.

As still another example, the computing device and/or the email application running on the computing device may be configured such that the Fast Sort mode discussed above is a separate, integrated view within the email client (e.g., in addition to the traditional List View of the email inbox). Thus, the user can browse through their inbox in the traditional List View and utilize the Fast Sort mode at key points in the time as they may wish. In other words, the Fast Sort mode might not be the only way that the user can move through their email within the email client. In addition, read messages, old messages, and other previously viewed messages may be displayed in the Fast Sort mode, in addition to unread and/or new messages. In this additional way, the Fast Sort mode may, at all times, provide the user with an accurate view of his or her inbox.

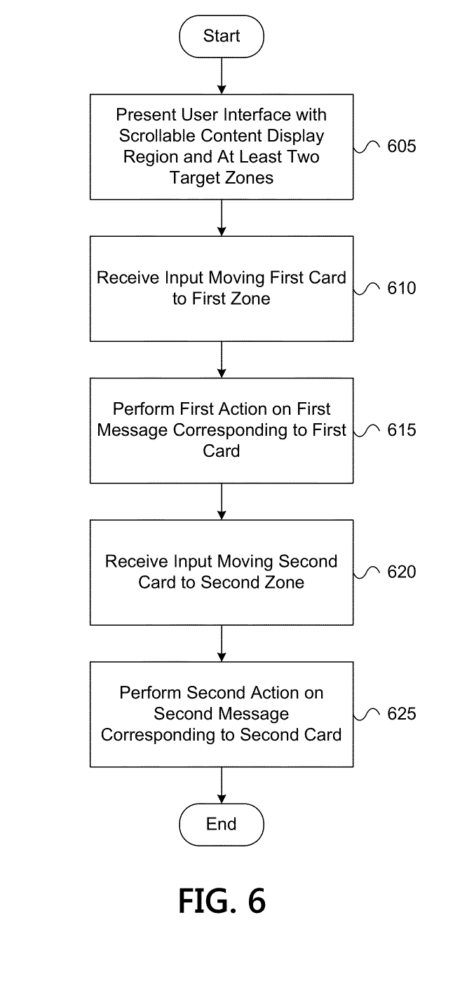

FIG. 6 depicts a flowchart that illustrates methods of providing enhanced message management user interfaces in accordance with one or more illustrative aspects discussed herein. In one or more embodiments, the method illustrated in FIG. 6 and/or one or more steps thereof may be performed by a computing device (e.g., generic computing device 100). Additionally or alternatively, the method illustrated in FIG. 6 and/or one or more steps thereof may, in some instances, be performed by a mobile device (which may implement one or more aspects of a computing device, such as generic computing device 100). In other embodiments, the method illustrated in FIG. 6 and/or one or more steps thereof may be embodied in computer-executable instructions that are stored in a computer-readable medium, such as a non-transitory computer-readable memory.

As seen in FIG. 6, the method may begin at step 605 in which a user interface may be presented. For example, at step 605, a computing device may present a user interface which includes a scrollable content display region and at least two target zones arranged along at least two different sides of the scrollable content display region. The scrollable content display region may include at least two message cards, and each message card may correspond to an email message. In presenting such a user interface, the computing device may, for example, generate and/or display the user interface and/or otherwise cause the user interface to be displayed (e.g., to a user of the computing device). In some instances, the user interface that may be presented at step 605 may be similar to example user interface 210 shown in FIG. 2.

Referring again to FIG. 6, at step 610, input moving a card to a target zone may be received. For example, at step 610, the computing device may receive first input moving a first message card of the at least two message cards to a first target zone of the at least two target zones. The first message card may be in focus (e.g., more prominently displayed and/or otherwise presented relative to the other message cards in the scrollable content display region, subjected to tap and/or swipe input received from the user of the computing device, and/or otherwise selected by the user, etc.) when and/or just before it is moved to the first target zone.

At step 615, an action may be performed on an email message corresponding to the message card that was moved to the target zone. For example, at step 615, in response to receiving the first input, the computing device may perform a first action on a first email message corresponding to the first message card. The action that is performed on the email message may correspond to the one or more actions identified in the target zone to which the message card is moved. For example, in example user interface 210 shown in FIG. 2, if in-focus message card 214a is moved to the target zone labeled “Archive” (e.g., as a result of receiving input swiping message card 214a upwards toward this target zone), then the computing device may perform an archive action on the email message corresponding to message card 214a. Alternatively, if in-focus message card 214a is moved to the target zone labeled “Delete” (e.g., as a result of receiving input swiping message card 214a downwards toward this target zone), then the computing device may perform a delete action on the email message corresponding to message card 214a. While this illustrated example shows the target zones having text labels for their corresponding actions, icons and/or other content may be similarly used to identify the one or more actions that may be associated with a particular target zone in other instances. In addition, after an action is performed on the message corresponding to the message card that was moved to the target zone (e.g., message card 214a), the next message card (e.g., message card 214b) may be placed into focus by the computing device. As illustrated below, the next message card may correspond to the next chronological message in the user's email inbox, for example.

Referring again to FIG. 6, at step 620, input moving another card to a target zone may be received. For example, at step 620, the computing device may receive second input moving a second message card of the at least two message cards to a second target zone of the at least two target zones. The second message card may be in focus (e.g., more prominently displayed and/or otherwise presented relative to the other message cards in the scrollable content display region, subjected to tap and/or swipe input received from the user of the computing device, and/or otherwise selected by the user, etc.) when and/or just before it is moved to the second target zone. For instance, the second message card may be placed into focus by the computing device, after the first message card is moved to a target zone and/or an action is performed on the corresponding message, as discussed above.

At step 625, an action may be performed on an email message corresponding to the message card that was moved to the target zone. For example, at step 625, in response to receiving the second input, the computing device may perform a second action different from the first action on a second email message corresponding to the second message card.

In one or more embodiments, at least one action of the first action and the second action may be defined by a user of the computing device. For example, the one or more actions that are assigned to and/or otherwise associated with each target zone of the at least two target zones may be user-customizable (e.g., instead of being fixed and/or otherwise constant), and at least one of the actions may be defined by the user of the computing device. For example, the computing device and/or a software application, such as an email client application, providing the user interface may be configured to allow the user to select an action to be assigned to a particular target zone from a list of available and/or predefined actions. Additionally or alternatively, the computing device and/or the software application may be configured to allow the user to create and/or otherwise define their own custom action, which may, for instance, be specified as a rule or as a group of rules that are to be applied to message(s) corresponding to message card(s) dropped on and/or otherwise moved to a particular target zone. Additionally or alternatively, the computing device and/or the software application may be configured to allow the user to otherwise create and/or define other settings and/or preferences that may specify one or more actions to be assigned to and/or otherwise associated with a particular target zone. In some instances, the actions that may be assigned to and/or otherwise associated with a particular target zone may include archiving a message, deleting a message, moving a message (e.g., to one or more specific folders), forwarding a message, flagging a message, bouncing a message, automatically responding to a message, marking a message as read, marking a message as unread, and/or performing various combinations of these and/or other actions. For example, a particular target zone included in the user interface may be used for a period of time as being assigned to and/or otherwise associated with a first action, and after interacting with a number of message cards and/or otherwise performing various actions on a number of messages, the user may re-define the particular target zone such that the target zone corresponds to another, different action. Subsequently, in this example, the user may interact with a different set of message cards to perform various other action(s) on a different set of messages by moving one or more message cards to the re-defined target zone.

In some embodiments, the computing device and/or the software application may be configured to automatically update one or more of the actions assigned to and/or otherwise associated with one or more target zones based on the folder for which one or more messages are currently being viewed and/or otherwise presented via the user interface. For example, when presenting message cards associated with messages in a user's inbox folder, the computing device and/or the software application may present target zones corresponding to an archive action and a delete action. But when presenting message cards associated with messages in a different folder (e.g., a sub-folder of the inbox, a sent messages folder, a search folder such as a “flagged” messages folder, etc.), the computing device and/or the software application may automatically update one or more actions so as to present target zones corresponding to one or more different actions, such as a “clear flag” action, a delete action, and/or other actions.

In some embodiments, a read-unread flag associated with each of the email messages corresponding to the at least two message cards may be preserved after the at least two message cards are presented in the scrollable content display region. For example, after presenting one or more message cards in the scrollable content display region, the computing device and/or the software application may maintain and/or otherwise might not alter the read-unread status of the one or more messages corresponding to the one or more presented message cards. Such a configuration may, for example, enable a user to initially sort messages (e.g., using a card view user interface) and subsequently return to a list view user interface to read through the full contents of the sorted messages (e.g., while ensuring that the user interface accurately reflects which messages have been read and which might have only been sorted and remain unread).

In some embodiments, a single message card of the at least two message cards may be in focus in the scrollable content display region at a time, and one or more other message cards of the at least two message cards may be presented differently than the single message card that is in focus in the scrollable content display region. For example, only one message card may be in focus in the scrollable content display region at any given time, and the in-focus message card may be displayed larger and/or more prominently than one or more other message cards that may be included in and/or presented in the scrollable content display region. Such a display is illustrated, for example, in FIG. 2 in which message card 214a is shown as being in focus and message card 214b is shown as being not in focus (and, e.g., is thus presented smaller and less prominently than message card 214a). The in-focus message card may, for instance, be the subject of input received in the scrollable content display region and may be the message card that is moved to a target zone as a result of such input.

In some embodiments, the single message card that is in focus in the scrollable content display region may include a preview of the email message corresponding to the single message card, and an amount of message content presented in the preview may be substantially similar to an amount of message content presented in a full-screen view of the email message corresponding to the single message card. For example, a similar amount of message text and/or other message content (or the same amount of message text and/or content in some instances) as presented when a particular message is viewed in a reading more or in a list view may be included in and/or presented with a message card corresponding to the particular message. Such an arrangement may, for example, allow the user to better sort through and/or apply actions to the messages corresponding to various message cards.

In some embodiments, performing the first action on the first email message may include causing a contextual menu to be presented, and the contextual menu may be configured to prompt a user to select a destination folder for the first email message. For example, after a message card is moved to a particular target zone, the computing device and/or the software application may cause a contextual menu to be presented that prompts the user of the computing device and/or the software application to select a folder to which the message corresponding to the message card should be moved.

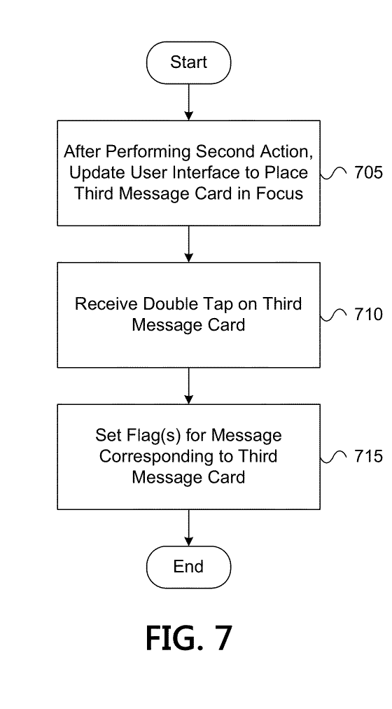

FIG. 7 depicts a flowchart that illustrates additional aspects of methods of providing enhanced message management user interfaces in accordance with one or more illustrative aspects discussed herein. In one or more embodiments, the method illustrated in FIG. 7 and/or one or more steps thereof may be performed by a computing device (e.g., generic computing device 100). Additionally or alternatively, the method illustrated in FIG. 7 and/or one or more steps thereof may, in some instances, be performed by a mobile device (which may implement one or more aspects of a computing device, such as generic computing device 100). In other embodiments, the method illustrated in FIG. 7 and/or one or more steps thereof may be embodied in computer-executable instructions that are stored in a computer-readable medium, such as a non-transitory computer-readable memory. In one or more embodiments, the method illustrated in FIG. 7 may be performed after and/or otherwise follow one or more of the other methods and/or method steps discussed herein, such as the example method discussed above with respect to FIG. 6.

As seen in FIG. 7, the method may begin at step 705 in which the user interface may be updated to place a third message card in focus. For example, after performing the second action on the second email message (e.g., at step 625), the computing device may update the user interface to place a third message card in focus in the scrollable content display region. In updating the user interface, the computing device may, for example, generate and/or display a revised and/or modified user interface to be displayed and/or otherwise cause such a user interface to be displayed (e.g., to a user of the computing device).

At step 710, input that includes a double tap on the third message card may be received. For example, at step 710, the computing device may receive third input corresponding to a double tap on the third message card. Such input may, for example, be received from the user of the computing device (e.g., using the user's finger, stylus, etc.) via a touch-sensitive display screen and/or other touch-sensitive surface included in and/or connected to the computing device.

At step 715, one or more flags may be set for the message corresponding to the third message card based on the input received at step 710. For example, at step 715, in response to receiving the third input, the computing device may set at least one flag for a third email message corresponding to the third message card. For instance, the message corresponding to the message card may be flagged (e.g., for follow up, for one or more other purposes by the user of the computing device and/or the software application, etc.) in response to receiving a double tap on the message card from the user of the computing device. While a double tap is an example of the input that, in some instances, may be received on the message card and may result in a corresponding message being flagged, in other instances, other input may similarly be received on the message card (e.g., a triple tap, one or more specific gestures, etc.) and the corresponding message may be similarly flagged and/or one or more other actions may be performed on the message.

In some embodiments, a third email message corresponding to the third message card may be associated with a conversation group that includes at least two email messages, and the at least two email messages included in the conversation group may be presented as an expandable stack in the scrollable content display region. For example, the third message may be part of a conversation or group of related email messages, and the computing device and/or the software application accordingly may present a stack of message cards (e.g., including an individual card for the third message and one or more other cards for the other related messages in the conversation group) as being in focus at once in the scrollable content display region. Similar to how the computing device and/or the software application may be configured to allow the user to move an individual message card to a target zone to perform an action on a corresponding message, the computing device and/or the software application also may be configured to allow the user to move the stack of message cards (e.g., at once, all together, etc.) to a target zone to perform an action on all of the messages in the conversation group. Additionally or alternatively, the computing device and/or the software application may be configured to flag all of the messages in the conversation group and/or perform other actions on all of the messages in the conversation group in response to receiving other input on and/or in connection with the stack of messages, such as input including a double tap on the stack of messages as in the examples discussed above.

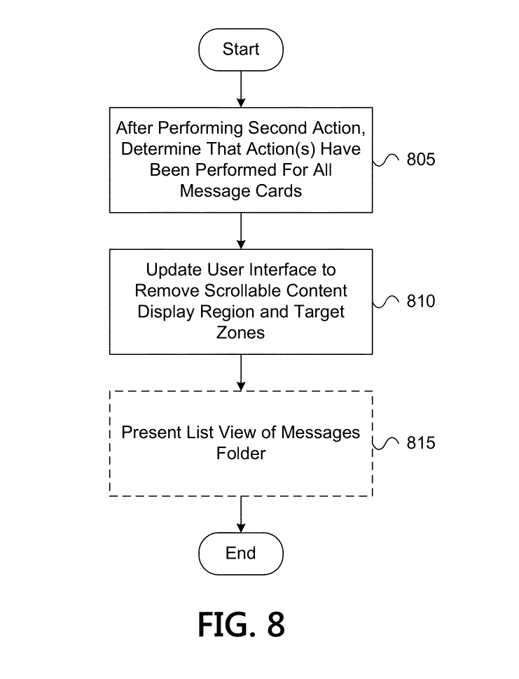

FIG. 8 depicts a flowchart that illustrates additional aspects of methods of providing enhanced message management user interfaces in accordance with one or more illustrative aspects discussed herein. In one or more embodiments, the method illustrated in FIG. 8 and/or one or more steps thereof may be performed by a computing device (e.g., generic computing device 100). Additionally or alternatively, the method illustrated in FIG. 8 and/or one or more steps thereof may, in some instances, be performed by a mobile device (which may implement one or more aspects of a computing device, such as generic computing device 100). In other embodiments, the method illustrated in FIG. 8 and/or one or more steps thereof may be embodied in computer-executable instructions that are stored in a computer-readable medium, such as a non-transitory computer-readable memory. In one or more embodiments, the method illustrated in FIG. 8 may be performed after and/or otherwise follow one or more of the other methods and/or method steps discussed herein, such as the example method discussed above with respect to FIG. 6.

As seen in FIG. 8, the method may begin at step 805 in which it may be determined that at least one action has been performed for all of the available message cards. For example, after performing the second action on the second email message (e.g., at step 625), the computing device may determine that at least one action has been performed on all email messages for which a message card was presented in the scrollable content display region.

At step 810, the user interface may be updated to remove the scrollable content display region and the target zones. For example, at step 810, in response to determining that at least one action has been performed on all email messages for which a message card was presented in the scrollable content display region, the computing device may update the user interface to remove the scrollable content display region and the at least two target zones. At step 815, a list view of a current messages folder may be presented. For example, at step 815, the computing device may present a list view of a messages folder that was previously being viewed and/or interacted with via the card view interface discussed above. In this way, after the user has sorted and/or otherwise interacted with all of the message cards presented in the Card View, the computing device and/or the software application (e.g., the email client application) running on the computing device may automatically exit the Card View mode and return to a conventional email viewing mode, such as the List View mode discussed above.

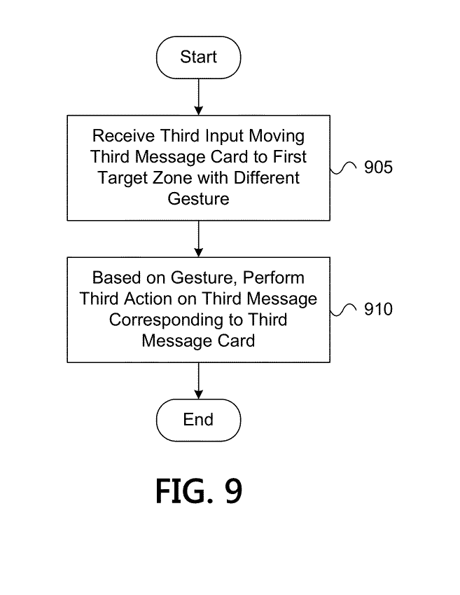

FIG. 9 depicts a flowchart that illustrates additional aspects of methods of providing enhanced message management user interfaces in accordance with one or more illustrative aspects discussed herein. In one or more embodiments, the method illustrated in FIG. 9 and/or one or more steps thereof may be performed by a computing device (e.g., generic computing device 100). Additionally or alternatively, the method illustrated in FIG. 9 and/or one or more steps thereof may, in some instances, be performed by a mobile device (which may implement one or more aspects of a computing device, such as generic computing device 100). In other embodiments, the method illustrated in FIG. 9 and/or one or more steps thereof may be embodied in computer-executable instructions that are stored in a computer-readable medium, such as a non-transitory computer-readable memory. In one or more embodiments, the method illustrated in FIG. 9 may be performed after and/or otherwise follow one or more of the other methods and/or method steps discussed herein, such as the example method discussed above with respect to FIG. 6.

As seen in FIG. 9, the method may begin at step 905 in which input moving a message card to the first target zone using a different gesture than was previously used in moving a message card to the same target zone may be received. For example, at step 905, the computing device may receive third input moving a third message card of the at least two message cards to the first target zone of the at least two target zones, and the third input may include a first gesture different from a second gesture that was used in moving the first message card to the first target zone.

At step 910, an action may be performed on a message corresponding to the message card based on both the target zone to which the message card was moved and the gesture that was used in moving the message card to the target zone. For example, at step 910, in response to receiving the third input, the computing device may perform a third action different from the first action on a third email message corresponding to the third message card. In this way, one action (e.g., an archive action) may be executed on a message in response to its corresponding message card being moved towards the first target zone using a first input gesture (e.g., a two-finger swipe), and a different action (e.g., a follow-up action, which may move the message to a particular folder, mark the message as unread, flag the message for follow up, and/or set a reminder, etc.) may be executed on the message in response to its corresponding message card being moved towards the same first target zone using a second input gesture (e.g., a three-finger swipe) different from the first input gesture. In some instances, the first gesture may be a two-finger swipe and the second gesture may be a one-finger swipe. In other instances, any other gestures may be used in a similar manner so as to overload the operations associated with a particular target zone.

In some embodiments, performing the third action may include performing an operation on a group of email messages that includes the third email message and one or more email messages related to the third email message. For example, the first action may be an operation that is performed on an email message corresponding to the particular message card that was moved to the target zone, while the third action (which may, e.g., be associated with the different gesture input) may be an operation that is performed on the email message corresponding to the message card that was moved to the target zone as well as a set or group of email messages that are related to the email message corresponding to the message card. In this way, the computing device and/or the software application running on the computing device may be configured so as to allow the user to provide input using different gestures to selectively apply an action to a conversation or other group of related messages simply by providing input in connection with and/or otherwise interacting with a single message card.

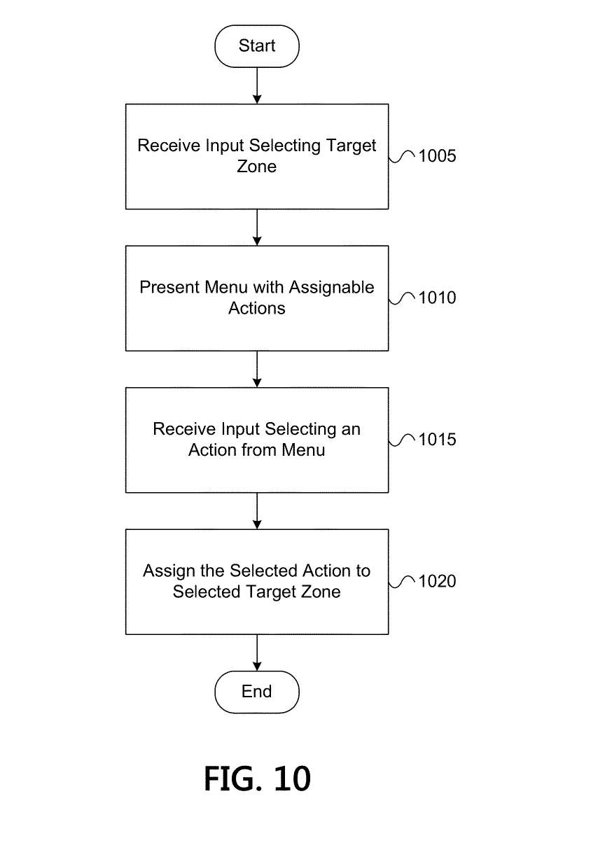

FIG. 10 depicts a flowchart that illustrates additional aspects of methods of providing enhanced message management user interfaces in accordance with one or more illustrative aspects discussed herein. In one or more embodiments, the method illustrated in FIG. 10 and/or one or more steps thereof may be performed by a computing device (e.g., generic computing device 100). Additionally or alternatively, the method illustrated in FIG. 10 and/or one or more steps thereof may, in some instances, be performed by a mobile device (which may implement one or more aspects of a computing device, such as generic computing device 100). In other embodiments, the method illustrated in FIG. 10 and/or one or more steps thereof may be embodied in computer-executable instructions that are stored in a computer-readable medium, such as a non-transitory computer-readable memory. In one or more embodiments, the method illustrated in FIG. 10 may be performed after and/or otherwise follow one or more of the other methods and/or method steps discussed herein, such as the example method discussed above with respect to FIG. 6.

As seen in FIG. 10, the method may begin at step 1005 in which input selecting a target zone may be received. For example, at step 1005, the computing device may receive third input selecting the first target zone of the at least two target zones. Such input may, for instance, include a tap, a double-tap, or another input gesture being performed on the first target zone by the user of the computing device.

At step 1010, a menu that includes a number of different actions that can be assigned to the selected target zone may be presented. For example, at step 1010, in response to receiving the third input, the computing device may present a menu that includes two or more actions that are assignable to the first target zone. For example, the menu may include various actions, such as an “Archive” action, a “Delete” action, a “Move” action, and/or other actions that may be assignable to the target zone. Such a menu is illustrated, for instance, in example user interface 510 in FIG. 5. In addition, a user may swipe through and/or otherwise scroll through the actions that are included in the menu, and as discussed below, may select an action to be assigned to the target zone by tapping on and/or otherwise selecting an action from the menu that is presented at step 1010.

Referring again to FIG. 10, at step 1015, input selecting an action from the menu that includes the various different assignable actions may be received. For example, at step 1015, the computing device may receive fourth input selecting an action of the two or more actions included in the menu. As noted above, such input may, for instance, be received as a tap, double tap, or other selection of an action included in the menu that is presented at step 1010.

At step 1020, the selected action may be assigned to the selected target zone. For example, at step 1020, in response to receiving the fourth input, the computing device may assign the selected action of the two or more actions to the first target zone. In assigning the selected action to the selected target zone, the computing device may, for instance, update the user interface such that the label associated with the target zone (e.g., for which the action has been assigned and/or re-assigned) correctly reflects the action that has been assigned to the target zone. Additionally or alternatively, as the user continues to interact with the user interface and/or move one or more message cards onto the target zone, the newly assigned action may be performed on one or more messages corresponding to the one or more message cards that are moved to the target zone.

While the example discussed above involves the first target zone being selected and an action for the first target zone being reassigned accordingly, a different target zone (e.g., the second target zone) may be similarly selected and an action for such a target zone may be similarly reassigned in other instances.

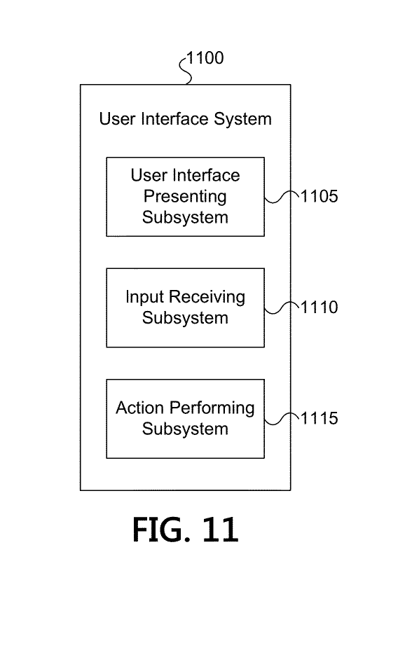

FIG. 11 depicts an example of a system for providing enhanced message management user interfaces in accordance with one or more illustrative aspects discussed herein. As seen in FIG. 11, system 1100 may be configured to provide and/or implement various aspects of the disclosure. In some embodiments, system 1100 may include various subsystems that all may be implemented in computer-executable instructions that are stored and/or executed by a single computing device. In other embodiments, system 1100 and its various subsystems may be implemented in computer-executable instructions that are stored and/or executed by multiple different computing devices. For example, each subsystem included in system 1100 may be a separate, specifically-configured computing device, and each separate computing device may be communicatively coupled to enable operation of the system.

In one or more embodiments, system 1100 may include a user interface presenting subsystem 1105, an input receiving subsystem 1110, and an action performing subsystem 1115. The configuration of system 1100 illustrated in FIG. 11 is one example configuration of system 1100 that may be used in some arrangements. In other arrangements, system 1100 may include additional and/or alternative subsystems in addition to and/or instead of those illustrated and discussed herein.

In some embodiments, user interface presenting subsystem 1105 may be configured to present one or more graphical user interfaces, such as one or more of the example user interfaces discussed above. For example, user interface presenting subsystem 1105 may be configured to present a user interface that includes a scrollable content display region that includes at least two message cards, where each message card corresponds to an email message, and at least two target zones arranged along at least two different sides of the scrollable content display region.

In some embodiments, input receiving subsystem 1110 may be configured to receive various types of input, such as user input received from a user of system 1100. For example, input receiving subsystem 1110 may be configured to receive first input moving a first message card of the at least two message cards to a first target zone of the at least two target zones. In addition, input receiving subsystem 1110 may be configured to receive second input moving a second message card of the at least two message cards to a second target zone of the at least two target zones.

In some embodiments, action performing subsystem 1115 may be configured to perform one or more actions on one or more messages, such as one or more email messages corresponding to one or more message cards. For example, action performing subsystem 1115 may be configured to perform a first action on a first email message corresponding to the first message card based on input received by input receiving subsystem 1110. In addition, action performing subsystem 1115 may be configured to perform a second action different from the first action on a second email message corresponding to the second message card based on input received by input receiving subsystem 1110.

As illustrated in the discussion above, various aspects of the disclosure may be embodied in various forms. For instance, various aspects of the disclosure may be embodied in a method, in a computing device, in computer-executable instructions stored in a computer-readable medium, and/or in an apparatus.

For example, various aspects of the disclosure may be embodied in a method in which a computing device may generate a user interface. The user interface may include a scrollable content display region, and the scrollable content display region may be configured to allow scrolling between at least two message cards, where each message card corresponds to an email message. In addition, the user interface may include at least two target zones, and the at least two target zones may be arranged along at least two different sides of the scrollable content display region. Subsequently, the computing device may cause the user interface to be displayed.

In some instances, a first action may be executed in response to a message card of the at least two message cards being moved towards a first target zone of the at least two target zones. Additionally, a second action may be executed in response to the message card being moved towards a second target zone of the at least two target zones, where the second action may be different from the first action, and the second target zone may be different from the first target zone. Furthermore, at least one of the first action and the second action may be user customizable. For example, the first target zone may be displayed at the top of the user interface, the second target zone may be displayed at the bottom of the user interface, different actions may be mapped to each of the target zones, and these actions may be user customizable, as illustrated in the examples discussed above.

In some embodiments, the user interface may be configured to provide a card view preview pane (which may, e.g., be included in the scrollable content display region and/or may, e.g., be formed by the message card(s) included in the scrollable content display region). Additionally, a read-unread flag associated with each of the email messages corresponding to the at least two message cards may be preserved after the at least two message cards are displayed in the card view preview pane.

In some embodiments, a single message card of the at least two message cards may be in-focus within the scrollable content display region at a time, and one or more other message cards of the at least two message cards may be displayed differently than the in-focus message card. For example, the in-focus message card may be displayed in the center of the scrollable content display region, and the other message cards may be displayed alongside the in-focus message card in a different manner (e.g., tilted or angled relative to the in-focus card, in a smaller size than the in-focus card, etc.), as illustrated in the example user interfaces depicted in FIGS. 2-5.

In some embodiments, an amount of message content included in each message card may be substantially similar to an amount of message content included in a full-screen view of the email message corresponding to each message card. For example, when viewing a message card in the scrollable content display region, the computing device may display, and the user may be able to view, about as much message content (if not the same amount of message content) as when the message is selected and displayed in a full-screen view in a traditional list view of an email client.

In some embodiments, in response to receiving user input moving a first message card of the at least two message cards to the first target zone, the computing device may cause a contextual menu to be displayed (e.g., by displaying a pop-up menu after a particular card is moved towards a particular action). In some instances, the contextual menu may be a folder menu that is configured to prompt a user to select a destination folder for a first email message corresponding to the first message card. For example, such a folder menu may be displayed as a pop-up menu if a “move” action is mapped to one of the target zones, and a user drags a message card onto the move action. Via the contextual menu, the user may, for instance, be able to specify a destination folder to which the particular message should be moved.

In some embodiments, the first action may be executed in response to the message card being moved towards the first target zone using a first user input gesture, and a third action may be executed in response to the message card being moved towards the first target zone using a second user input gesture, where the third action may be different from the first action, and the second user input gesture may be different from the first user input gesture. In some instances, the first user input gesture may be a one-finger swipe and the second user input gesture may be a two-finger swipe. In some additional instances, the first action may be an operation performed on an email message corresponding to the message card, and the third action may be an operation performed on a group of email messages related to the email message corresponding to the message card. For example, a user may be able to single-finger swipe a message card to perform an action (e.g., delete, archive, move, etc.) on a single message, and the user may be able to double-finger swipe the message card to perform the same action or a different action (e.g., delete, archive, move, etc.) on a group of messages related to the message corresponding to the message card. The group of messages related to the particular message may, for instance, be other messages that are part of the same conversation as the particular message. By swiping with different gestures in this way, the user may be able to quickly perform action(s) either on a single message or on an entire group of messages related to the message corresponding to the particular message card.

In other examples, various aspects of the disclosure may be embodied in a computing device that includes at least one processor and memory storing computer-readable instructions that, when executed by the at least one processor, cause the computing device to perform any and/or all of the methods discussed above. In still other examples, various aspects of the disclosure may be embodied in one or more computer-readable media (which may, e.g., include a non-transitory computer-readable memory) storing instructions that, when executed by at least one processor, cause the at least one processor to perform any and/or all of the methods discussed above. In yet other examples, various aspects of the disclosure may be embodied in an apparatus comprising one or more means for performing any and/or all of the methods discussed above.

As illustrated above, various aspects of the disclosure relate to providing enhanced user interfaces. Although the subject matter has been described in language specific to structural features and/or methodological acts, it is to be understood that the subject matter defined in the appended claims is not necessarily limited to the specific features or acts described above. Rather, the specific features and acts described above are described as some example implementations of the following claims.

What is claimed is:

1. A method, comprising:
presenting, by a computing device, a user interface comprising:
a scrollable content display region that includes at least two message cards, each message card corresponding to an email message; and
at least two target zones arranged along at least two different sides of the scrollable content display region;
receiving, by the computing device, first input moving a first message card of the at least two message cards to a first target zone of the at least two target zones;
in response to receiving the first input, performing, by the computing device, a first action on a first email message corresponding to the first message card;
receiving, by the computing device, second input moving a second message card of the at least two message cards to a second target zone of the at least two target zones; and
in response to receiving the second input, performing, by the computing device, a second action different from the first action on a second email message corresponding to the second message card,
wherein at least one action of the first action and the second action is defined by a user of the computing device.

2. The method of claim 1, further comprising:
after performing the second action on the second email message, updating, by the computing device, the user interface to place a third message card in focus in the scrollable content display region.

3. The method of claim 2, further comprising:
receiving, by the computing device, third input corresponding to a double tap on the third message card; and
in response to receiving the third input, setting, by the computing device, at least one flag for a third email message corresponding to the third message card.

4. The method of claim 2,
wherein a third email message corresponding to the third message card is associated with a conversation group that includes at least two email messages, and
wherein the at least two email messages included in the conversation group are presented as an expandable stack in the scrollable content display region.

5. The method of claim 1, further comprising:
after performing the second action on the second email message, determining, by the computing device, that at least one action has been performed on all email messages for which a message card was presented in the scrollable content display region; and
in response to determining that at least one action has been performed on all email messages for which a message card was presented in the scrollable content display region, updating, by the computing device, the user interface to remove the scrollable content display region and the at least two target zones.

6. The method of claim 1,
wherein a read-unread flag associated with each of the email messages corresponding to the at least two message cards is preserved after the at least two message cards are presented in the scrollable content display region.

7. The method of claim 1, wherein a single message card of the at least two message cards is in focus in the scrollable content display region at a time, and one or more other message cards of the at least two message cards are presented differently than the single message card that is in focus in the scrollable content display region.

8. The method of claim 7,
wherein the single message card that is in focus in the scrollable content display region includes a preview of the email message corresponding to the single message card, and
wherein an amount of message content presented in the preview is substantially similar to an amount of message content presented in a full-screen view of the email message corresponding to the single message card.

9. The method of claim 1,
wherein performing the first action on the first email message includes causing a contextual menu to be presented, the contextual menu being configured to prompt a user to select a destination folder for the first email message.

10. The method of claim 1, further comprising:
receiving, by the computing device, third input moving a third message card of the at least two message cards to the first target zone of the at least two target zones, the third input including a first gesture different from a second gesture used in moving the first message card to the first target zone; and
in response to receiving the third input, performing, by the computing device, a third action different from the first action on a third email message corresponding to the third message card.

11. The method of claim 10, wherein the first gesture is a two-finger swipe and the second gesture is a one-finger swipe.

12. The method of claim 11,
wherein performing the third action includes performing an operation on a group of email messages that includes the third email message and one or more email messages related to the third email message.

13. The method of claim 1, further comprising:
receiving, by the computing device, third input selecting the first target zone of the at least two target zones;
in response to receiving the third input, presenting, by the computing device, a menu comprising two or more actions that are assignable to the first target zone;
receiving, by the computing device, fourth input selecting an action of the two or more actions included in the menu; and
in response to receiving the fourth input, assigning, by the computing device, the selected action of the two or more actions to the first target zone.

14. One or more non-transitory computer-readable media having computer-executable instructions stored thereon that, when executed, cause at least one computing device to:
present a user interface comprising:
a scrollable content display region that includes at least two message cards, each message card corresponding to an email message; and
at least two target zones arranged along at least two different sides of the scrollable content display region;
receive first input moving a first message card of the at least two message cards to a first target zone of the at least two target zones;
in response to receiving the first input, perform a first action on a first email message corresponding to the first message card;
receive second input moving a second message card of the at least two message cards to a second target zone of the at least two target zones; and
in response to receiving the second input, perform a second action different from the first action on a second email message corresponding to the second message card,
wherein at least one action of the first action and the second action is defined by a user of the at least one computing device.

15. The one or more non-transitory computer-readable media of claim 14, having additional computer-executable instructions stored thereon that, when executed, further cause the at least one computing device to:
after performing the second action on the second email message, update the user interface to place a third message card in focus in the scrollable content display region.

16. The one or more non-transitory computer-readable media of claim 15, having additional computer-executable instructions stored thereon that, when executed, further cause the at least one computing device to:
receive third input corresponding to a double tap on the third message card; and
in response to receiving the third input, set at least one flag for a third email message corresponding to the third message card.

17. The one or more non-transitory computer-readable media of claim 14, having additional computer-executable instructions stored thereon that, when executed, further cause the at least one computing device to:
after performing the second action on the second email message, determine that at least one action has been performed on all email messages for which a message card was presented in the scrollable content display region; and
in response to determining that at least one action has been performed on all email messages for which a message card was presented in the scrollable content display region, update the user interface to remove the scrollable content display region and the at least two target zones.

18. The one or more non-transitory computer-readable media of claim 14, having additional computer-executable instructions stored thereon that, when executed, further cause the at least one computing device to:
receive third input moving a third message card of the at least two message cards to the first target zone of the at least two target zones, the third input including a first gesture different from a second gesture used in moving the first message card to the first target zone; and
in response to receiving the third input, perform a third action different from the first action on a third email message corresponding to the third message card.

19. The one or more non-transitory computer-readable media of claim 14, having additional computer-executable instructions stored thereon that, when executed, further cause the at least one computing device to:
receive third input selecting the first target zone of the at least two target zones;
in response to receiving the third input, present a menu comprising two or more actions that are assignable to the first target zone;
receive fourth input selecting an action of the two or more actions included in the menu; and
in response to receiving the fourth input, assign the selected action of the two or more actions to the first target zone.

20. A computing device, comprising:
at least one processor; and
memory storing computer-readable instructions that, when executed by the at least one processor, cause the computing device to:
present a user interface comprising:
a scrollable content display region that includes at least two message cards, each message card corresponding to an email message; and
at least two target zones arranged along at least two different sides of the scrollable content display region;
receive first input moving a first message card of the at least two message cards to a first target zone of the at least two target zones;
in response to receiving the first input, perform a first action on a first email message corresponding to the first message card;
receive second input moving a second message card of the at least two message cards to a second target zone of the at least two target zones; and
in response to receiving the second input, perform a second action different from the first action on a second email message corresponding to the second message card,
wherein at least one action of the first action and the second action is defined by a user of the computing device.
